(19) United States
(12) Patent Application Publication
(10) Pub. No.: US 2015/0318768 A1
(43) Pub. Date: Nov. 5, 2015

(54) CONTACT ELEMENT FOR AN ELECTRIC MACHINE

(71) Applicant: ROBERT BOSCH GMBH, Stuttgart (DE)

(72) Inventors: Jan Schlegel, Shanghai (CN); Lukas Leitz, Kuppenheim (DE); Andreas Ewert, Lichenau (DE); Thomas Devermann, Achern-Fautenbach (DE)

(73) Assignee: Robert Bosch GmbH, Stuttgart (DE)

(21) Appl. No.: 14/761,961

(22) PCT Filed: Dec. 6, 2013
(86) PCT No.: PCT/EP2013/075808

§ 371 Date: Jul. 20, 2015

(30) Foreign Application Priority Data
Jan. 18, 2013 (DE) 10 2013 200 794.9

(51) Int. Cl. H02K 13/04; H01R 39/02

(52) U.S. Cl. CPC H02K 13/04; H01R 39/025

(57) ABSTRACT

The invention relates to a contact element (10; 10′; 10″; 10′″) for providing an electrical contact to an electric machine, particularly in a motor vehicle, comprising: a first contact section (13; 14; 18; 21′) formed from a first material; and a second contact section (11; 17′; 11; 23) formed from a second material that is different from the first material, wherein the first contact section and the second contact section are connected by means of a multi-component connection (16; 16′; 16″; 16′″).

### BACKGROUND OF THE INVENTION

The invention relates generally to a contact element for an electric machine, in particular in a motor vehicle.

Commutators in electric motors are known, wherein the commutators consist of a thermoset molding compound as carrier and lamellae made of copper.

The lamellae are used both as an electric contact surface to the current-carrying carbon brushes and as winding wires of a rotor winding, which are currently formed from copper in most electric machines. The winding wires are installed in electric machines in such a way that they form a winding arrangement so as to be able to develop a magnetic flux.

The electrical contact between the lamella and the winding wire can be formed via a contact hook, which is provided at the end of the commutator lamella. A partial tin coating can be provided in an inner region of a contact hook in order to improve the contact. In order to produce the contact, the end of a winding wire of the rotor winding is inserted into the contact hook and is fixed in place.

Because copper is costly as winding material, a more economical replacement is sought. Nowadays, winding wires made of aluminum instead of copper are considered increasingly.

In the case of a use of aluminum wire for contacting a copper contact hook of the commutator, methods are known that are based on soft soldering. However, these are disadvantageous in respect of durability in the case of long-lasting high operating temperatures of the electric machine. A mechanical load-bearing capacity of such an arrangement is also insufficient.

Furthermore, in the case of contact between the copper of the commutator lamellae and the material of the winding arrangement, the transition resistance may increase, since unstable intermetallic phases may occur.

When assembled and fastened on the commutator, the winding wire may be crimped, thus reducing the wire cross section thereof. With a narrowing crimp connection from the winding wire to the contact hook, the wire cross section for the rotor winding is therefore selected so as to be greater than would be necessary for the electrical properties of the electric machine. This leads to restrictions with regard to the construction of the electric machine.

### SUMMARY OF THE INVENTION

The object of the present invention is therefore to provide an improved contact element in a simple manner, in particular a contact element which provides reliable contact between a connector of an electric machine and a conductor to a winding arrangement in the electric machine, in particular with a material of the conductor different from the material of the connector.

This object is achieved by a contact element for electrical contact in an electric machine, preferably in a motor vehicle, a contact arrangement, and also by an electric machine, in particular in a motor vehicle.

In accordance with a first aspect, a contact element is created for providing electrical contact to an electric machine, in particular in a motor vehicle, comprising: a first contact portion formed from a first material; and a second contact portion formed from a second material that is different from the first material, wherein the first contact portion and the second contact portion are connected by means of a multi-component connection.

One concept of the above contact element is to provide electrical contact between a connector of the machine and a conductor to a winding arrangement within the electric machine in such a manner that contact involving the same materials or at least compatible materials is provided between the contact elements and the winding arrangements.

It is thus possible to electrically connect the winding arrangement to the contact element without producing a multi-component connection at this connection area. Intermetallic phases, which have a significantly increased transition resistance, are produced by a multi-component connection. This is disadvantageous for the electrical properties of the electric machine. This disadvantage is avoided by the proposed contact element in the region of contact between the winding arrangement and the energy feed.

The contact element provided as described enables a largely free selection of the winding material. Since a relatively large amount of winding material is necessary for the winding arrangement, it is possible, without technical losses, to switch to a more cost-effective winding material if the previously used winding material has become too costly for an economical use.

In other words, it is thus possible to provide high material availability in a winding arrangement cost-effectively, wherein good electrical contact and mechanically reliable contact to the connector of the machine is maintained.

It is envisaged to provide a contact element as described in a prefabricated manner, such that, when producing the electric machine and when contacting the winding arrangement, only contact involving the same materials or at least compatible materials is established between the winding arrangement and the prefabricated contact element, such that the electric machine is easily produced, yet mechanically stable and temperature-resistant, good electrical contact is provided from outside to the winding arrangement, via a connector of the electric machine.

Contact involving compatible materials is understood in particular to mean contact between different materials in which there are no, or substantially no intermetallic phases, or between materials that are different, but largely similar.

In the present case, a contact element is thus understood in particular to mean a construction that provides electrically conductive contact or an electrically conductive connection between a connector to the electric machine and a winding arrangement of the electric machine or a conductor to the winding arrangement.

A multi-component connection is understood here in particular to mean a connection that is formed from at least two different conductive materials.

A contact element which, as described, comprises a first contact portion made of a first material and a second contact portion which is connected to the first contact portion via a multi-component connection and is made of a second material that is different from the first material can be referred to as a multi-component system.

A first contact portion is understood here in particular to mean the portion of the contact element that is associated with the winding arrangement. In other words, the first contact portion is connected either directly to an end of a winding of the winding arrangement or to a conductor leading to the winding arrangement.

Winding material means the material from which the conductive components of the winding arrangement are made. In the case of a DC motor, the first contact portion can be formed as commutator hooks or slot.

The first material of the contact element can be identical to the winding material. Alternatively, the first material of the contact element can be compatible with the winding material.

A second contact portion is understood here in particular to mean the portion associated with the connector of the electric machine.

Furthermore, the contact element can be formed in such a way that the winding-side contact portion is directly connected to the feed-side contact portion and thus provides the multi-component connection.

Alternatively, the contact element can be formed in such a way that the winding-side contact portion is indirectly connected to the feed-side contact portion via a contact portion providing the multi-component connection.

It may be that the winding material of the electric machine is formed substantially from aluminum. Since aluminum is more economical than copper, a cost saving is thus provided on the whole. It is envisaged to provide a conductor that electrically connects the first contact portion of the contact element to the winding material. Alternatively, an end of a winding is electrically connected directly to the first contact portion of the contact element.

In particular, in the case of a use of aluminum as the winding material, the insulation thereof can be formed by means of eloxation. The wire lacquering required in the conventional case of copper wire as the winding material is thus unnecessary.

In accordance with an embodiment, the second contact portion of the contact element can be formed substantially of copper. This is the material used conventionally, for example in the case of the lamellae of a commutator of a DC motor or the feed lines from an electronic commutator to winding connectors of an electronically commutated (EC) motor.

It is envisaged to provide a contact element with a first contact portion formed from aluminum or material compatible with aluminum and with a second contact portion formed from copper or material compatible with copper, wherein the first contact portion is associated with the winding arrangement and the second contact portion is associated with the connector of the electric machine.

The electric machine may be one of a DC motor, an EC motor, a generator and a transformer. In the case of a DC motor, the contact element will be provided on the commutator and will provide electrical contact between a commutator lamella and a line to the winding arrangement. The energy feed from outside is then provided in a manner known per se via a carbon brush, which sweeps over the commutator and contacts the lamellae alternately as the commutator rotates.

In the case of an EC motor, a control connector of a suitable control device for supplying and activating a field winding arrangement is connected to the feed-side contact portion. In this case it is envisaged to form a rotor of the EC motor as a permanent magnet.

In the case that the electric machine is a transformer, it is envisaged to use the described contact element at least on the side of the transformer on which the winding arrangement has the most windings.

In accordance with an embodiment the multi-component connection of the winding-side contact portion to the feed-side contact portion can be provided by one of WIG welding, TIG welding, MIG welding, MAG welding, resistance welding, friction welding, laser welding, soldered connection with flux agent, and soldered connection without flux agent, and also with or without ultrasound assistance. A mechanically and thermally stable connection is thus provided between the winding-side contact portion and the feed-side contact portion.

In accordance with a further aspect a contact arrangement is provided, comprising a contact element as described above and a conductor connecting the winding-side contact portion to the winding arrangement, wherein the conductor is formed, at least in a region of the winding-site contact portion, from two portions formed from different materials.

In accordance with yet a further aspect an electric machine, in particular in a motor vehicle, is provided, wherein contact is formed between an energy supply and a winding arrangement in the electric machine by a contact element as previously described and/or by a contact arrangement as previously described.

The described contact element provides robust contact and a continuously low transition resistance.

In the case of a DC motor, a carrier formed from a number of materials, at least two, is used by way of example. Here, these materials may be copper and aluminum, for example. The carrier material can be produced by roll cladding or friction welding.

A structure as described above can be detected for example by disassembly of the electric machine and by microsections as well as by appropriate physical and chemical analyses.

### BRIEF DESCRIPTION OF THE DRAWINGS

Preferred embodiments of the present invention will be explained in greater detail hereinafter on the basis of the accompanying drawings. Here, similar reference signs are used for identically or similarly acting components, unless specified otherwise. In the drawings:

FIG. 1 shows a cross section through an electric machine formed as a brushed DC motor;

FIGS. 2a-2b show schematic illustrations of an embodiment for the purpose of explanation;

FIGS. 3a-3i show schematic illustrations of embodiments in which a winding-side conductor is fastened to a winding-side contact portion in the form of a commutator hook;

FIGS. 4a-4b show a schematic illustration of embodiments in which a winding-side conductor is fastened to a winding-side contact portion in the form of a slot; and

FIGS. 5a-5d show a schematic illustration of embodiments in which a winding-side conductor is welded to a winding-side contact portion.

### DETAILED DESCRIPTION

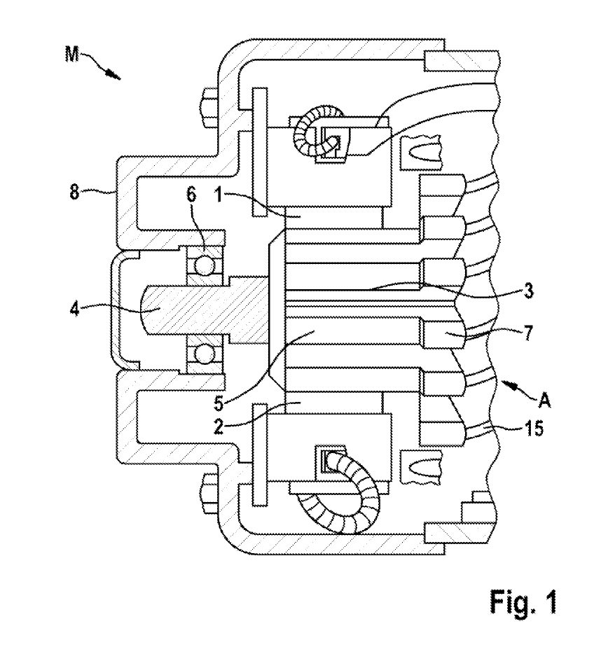

FIG. 1 shows a partial cross section through an electric machine M formed as a brushed DC motor. The electric machine M has a housing 8, in which an armature A is held on a mount 6 via a shaft 4 associated with said armature. It is not shown that the armature 4 is also held at its opposite end on a second mount.

The electric machine M also has a commutator 3. The commutator 3 comprises lamellae 5, which are contacted via carbon brushes 1 and 2. The carbon brushes 1 and 2 to this end touch lamellae 5 of a commutator 3 formed in lamellae and thus produce electrical contact between a connector (not shown) and a winding arrangement (not shown), in this case an armature winding arrangement. A contact portion 7 provides contact between the lamellae and a conductor 15 leading to the winding arrangement.

Current is fed to the winding arrangement of the armature A via the commutator 3 formed in lamellae 5 via the carbon brushes 1 and 2. If the armature A is supplied in this way with current, an armature magnetic field is thus developed that interacts with an existing stator magnetic field in such a way that torque acts on the armature A, such that this rotates. Here, the carbon brushes lose the contact to the previously contacted lamellae of the commutator and establish contact with lamellae of the commutator that are arranged next in the direction of rotation and that are associated with a further winding arrangement on the armature, such that an armature magnetic field is again developed that in turn interacts with the existing stator magnetic field in such a way that a force is exerted onto the armature A, such that this continues to rotate. In other words, the commutator is used to generate the armature magnetic field continuously at a predefined angle to the stator magnet, in such a way that a substantially constant torque can act continuously on the armature A.

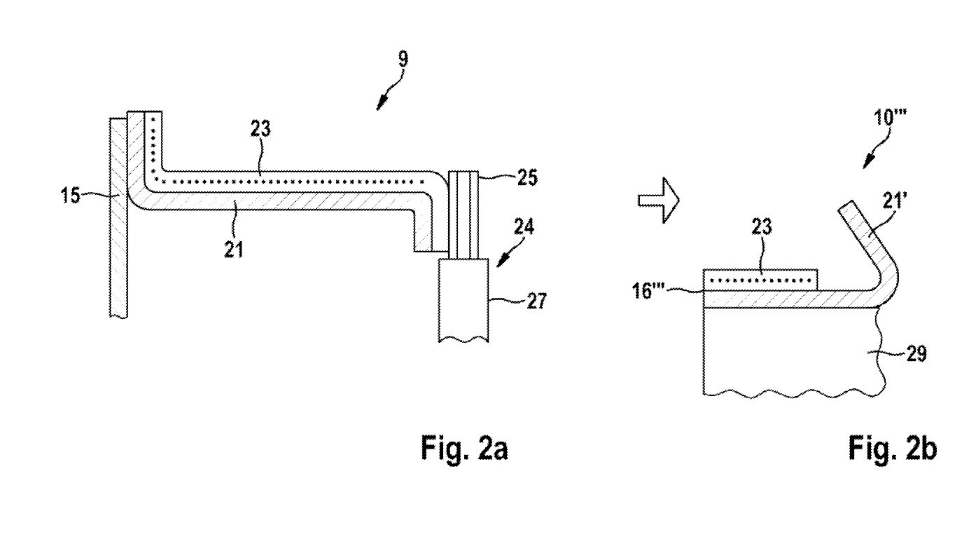

FIGS. 2a-2b, for the purpose of explanation, show in detail a schematic illustration of an embodiment. FIG. 2a illustrates a simply illustrated reproduction of an embodiment. A contact element 9, which corresponds in terms of function to the contact element 7 from FIG. 1, is formed from a first contact portion 21, which is formed from a first material, and from a second contact portion 23, which is fastened on said first contact portion and is formed from a second material. A conductor 15 leads to a winding arrangement (not shown) of an electric machine.

The conductor 15 is formed from the same material as the first contact portion 21 or at least from a material compatible therewith, which forms no, or substantially no intermetallic phase with the first material.

The second contact portion 23 by contrast is formed from a second material that is different from the first material. The contact portion 23 is connected via a stripped end 25 of a feed conductor 24, which is formed from the second material, to a connector (not shown) of the electric machine. Here, the feed conductor 24 is additionally illustrated provided with insulation 27.

In this way, the winding arrangement is connected to the first contact portion 21 of the contact element 9, and the connector is connected to the second contact portion 23 of the contact element 9, in each case in a manner involving the same materials or compatible materials. The material transition between the first material and the second material is thus provided by the contact element 9 in that a fixed multi-component connection has been created between the first contact portion 21 and the second contact portion 23.

A mechanically and thermally stable electrical connection between the connector and the winding arrangement is thus provided, because either connections involving the same materials or a connection provided in a particularly stable manner between the different materials are created.

Proceeding from this rather isolated exemplary consideration, a contact element 7 of FIG. 1 is shown schematically in FIG. 2b, here as a contact element 10′″: a first contact portion 21′ formed from the first material, also referred to as a commutator hook 21′, is fastened on a carrier 29 of the commutator 3 from FIG. 1, illustrated here merely in partial section. The first material may be the same as the material from which the windings of the electric machine are formed, for example aluminum. Alternatively, the first material may be a material compatible with aluminum. The commutator also has a contact portion 23, which is formed from the second material, is associated with the connector of the electric machine, and is also referred to as a lamella 23.

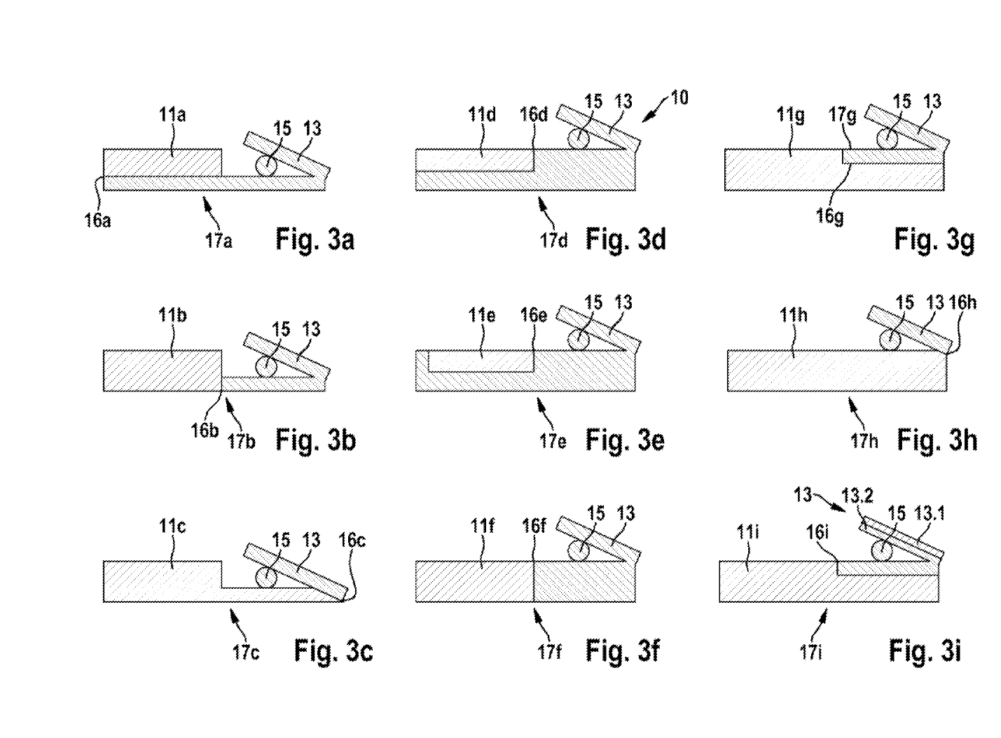

FIGS. 3a-3i show schematic illustrations of embodiments in which a winding-side conductor is fastened to a winding-side contact portion in the form of a commutator hook.

In accordance with an embodiment, a contact element 10 is used to provide electrical contact between a connector of an electric machine and a winding arrangement in an electric machine, said winding arrangement being formed from a winding material. The contact element 10 comprises a winding-side contact portion 13 formed from a first material, which may be a winding material or a material compatible therewith, and a second contact portion 11a to 11i, which is associated with the connector and which is formed from a second material that is different from the winding material, wherein the first contact portion 13 and the second contact portion 11a to 11i are connected by means of a multi-component connection 16a to 16i.

In the case of a brushed DC motor, the winding-side contact portions 13 are commutator hooks 13, for example. The commutator hook 13 is formed from a portion that is aligned with the commutator lamella and that rests on the commutator carrier and from a portion that is bent back at an angle from the commutator carrier, to the end of which portion a conductor 15 leading to the winding arrangement is fastened. In the simplest case, a commutator hook can be formed by a lamella that initially protrudes beyond the commutator carrier and is then bent back. Furthermore, the end of the conductor 15 connected to the commutator hook can be pinched by bending back the protruding portion of the lamella, in such a way that said conductor is held on the lamella, thus providing a conductive connection.

Via the second contact portion 11a to 11i connected to the connector, an electrical connection can thus be created via the first contact portion 13 to the conductor 15 and thus to the winding arrangement.

A feature common to the embodiments shown in FIGS. 3a-3i is that a winding-side or first contact portion 13, which is fabricated from a winding material or from a material compatible with the winding material, which is referred to as the first material, is electrically contacted with a conductor 15, which is also fabricated from the winding material and leads to a winding arrangement. It is envisaged that the winding arrangement is formed as a whole from the conductor 15.

The winding-side contact portion 13 can constitute a commutator hook, for example. In this case a feed-side contact portion 11 then constitutes a lamella of a commutator.

FIG. 3a shows a contact element 10. A first contact portion 13, which is formed from a first material, is directly connected to a contact portion 17a providing a multi-component connection, said contact portion also being formed from the first material. The first contact portion 13 is then bent back in such a way that a conductor 15 can be wedged between the first contact portion 13 and the contact portion 17a. The contact portion 17a, as can be seen from the cross section, is electrically connected over a large area to a second contact portion 11a, wherein the second contact portion 11a is formed from a second material. The second contact portion 11a is connected to the contact portion 17a via a multi-component connection 16a, which is provided by one of WIG welding, TIG welding, MIG welding, MAG welding, resistance welding, friction welding, laser welding, soldered connection with flux agent and soldered connection without flux agent. The aforementioned methods can further be assisted by means of an ultrasound method. In other words, the second contact portion 11a appears placed on the contact portion 17a parallel to a longitudinal extension thereof.

The first contact portion 13 is thus indirectly connected to the second contact portion 11a via the contact portion 17a providing the multi-component connection 16a.

In accordance with FIG. 3b, a first contact portion 13 made of a first material is provided and is directly connected to a contact portion 17b. The first contact portion 13 is bent back with respect to the contact portion 17b in such a manner that a conductor 15 can be wedged between the first contact portion 13 and the contact portion 17b. A second contact portion 11b formed from a second material is contacted in abutment against the contact portion 17b, formed from the first material, in the direction of longitudinal extension thereof. A multi-component connection 16b formed between the contact portion 17b and the second contact portion 11b has a smaller area than in the previous example.

The first contact portion 13 is thus indirectly connected to the second contact portion 11b via the contact portion 17b providing the multi-component connection 16b.

FIG. 3c shows a contact element 10, in which a first contact portion formed from a first material is directly connected to a second contact portion 11c formed from a second material. The first contact portion is connected via a multi-component connection 16c to the second contact portion 11c. In other words, the second contact portion 11c is provided in one piece with the contact portion 17c. The first contact portion 13 has an acute angle with the contact portion 17c, such that a conductor 15 can be wedged between the first contact portion 13 and the contact portion 17c. The multi-component connection 16c between the first contact portion 13 and the contact portion 17c can be produced in the manner already known.

The first contact portion 13 is thus directly connected to the second contact portion 11c, such that the multi-component connection 16c is thus provided.

FIG. 3d illustrates a contact element 10 in which a first contact portion 13 formed from a first material is indirectly connected to a contact portion 11d formed from a second material. The first contact portion 13 is directly connected to a contact portion 17d and adopts an acute angle therewith, such that a conductor 15 can be wedged between the first contact portion 13 and the contact portion 17d. The contact portion 17d tapers in a stepped manner in the direction of longitudinal extension thereof, as considered from the point of connection with the first contact portion 13. The second contact portion 11d is formed in the step. A multi-component connection 16d is created between the second contact portion 11d and the contact portion 17d.

The first contact portion 13 is thus indirectly connected to the second contact portion 11d via the contact portion 17d providing the multi-component connection 16d.

FIG. 3e shows a contact element 10 that has a first contact portion 13 which is formed from a first material and which is formed on a contact portion 17e formed from the first material. The first contact portion 13 has an acute angle with the contact portion 17e, such that a conductor 15 can be wedged between the first contact portion 13 and the contact portion 17e. The contact portion 17e has a recess, in which a second contact portion 11e formed from a second material is formed. A multi-component connection 16e is created between the second contact portion 11e and the contact portion 17e.

The first contact portion 13 is thus indirectly connected to the second contact portion 11e via the contact portion 17e providing the multi-component connection 16e.

FIG. 3f shows a contact element 10. A first contact portion formed from a first material is formed on a contact portion 17f and has an acute angle therewith, such that a conductor 15 can be wedged between the first contact portion 13 and the contact portion 17f. A second contact portion 11f formed from a second material is connected in abutment as considered in the direction of extension of the contact portion 17f from the first contact portion. A multi-component connection 16f is created between the second contact portion 11f and the contact portion 17f.

The first contact portion 13 is thus indirectly connected to the second contact portion 11f via the contact portion 17f providing the multi-component connection 16f.

FIG. 3g shows a contact element 10, in which a first contact portion 13 formed from a first material is applied to a contact portion 17g formed from the first material. The first contact portion 13 and the contact portion 17g adopt an acute angle to one another, such that a conductor 15 can be wedged between the first contact portion 13 and the contact portion 17g. The contact portion 17g is formed in a step of a second contact portion 11g, which becomes larger in a stepped manner in the direction of extension of the contact portion 17g, as considered from the first contact portion 13, and which is formed from a second material. A multi-component connection 16g is created between the second contact portion 11g and the contact portion 17g.

The first contact portion 13 is thus indirectly connected to the second contact portion 11g via the contact portion 17g providing the multi-component connection 16g.

FIG. 3h shows a contact element 10, in which a first contact portion 13 formed from a first material is fastened to a second contact portion 11h formed from a second material. The first contact portion 13 adopts an acute angle with the second contact portion 11h, such that a conductor arranged between the first contact portion 13 and the second contact portion 11h can be wedged between the first contact portion 13 and the second contact portion 11h. The first contact portion 13 is directly connected to the second contact portion 11h via a multi-component connection 16h. In this embodiment a contact portion 17h is identical to the second contact portion 11h.

The first contact portion 13 is thus directly connected to the second contact portion 11h, such that the multi-component connection 16h is provided in this way.

FIG. 3i shows a contact element 10, in which the first contact portion is formed from a portion made of a first material 13.2 and from a portion made of a further material 13.1. The first contact portion 13 is connected on the side 13.2 formed from the first material to a contact portion 17i formed from the first material. The first contact portion 13 and the contact portion 17i adopt an acute angle, such that a conductor 15 placed between the side 13.2 of the first contact portion 13 formed from the first material and the contact portion 17i can be wedged therebetween. The contact portion 17i is formed in a recess of a second contact portion 11i, which is formed from a second material and which widens in a stepped manner in the direction of extension of the contact portion 17i, as considered from the first contact portion 13. The contact portion 11i is connected to the contact portion 17i via a multi-component connection 16i.

The first contact portion 13 is thus indirectly connected via its portion formed from the first material 13.1 to the second contact portion 11i via the contact portion 17i providing the multi-component connection 16i.

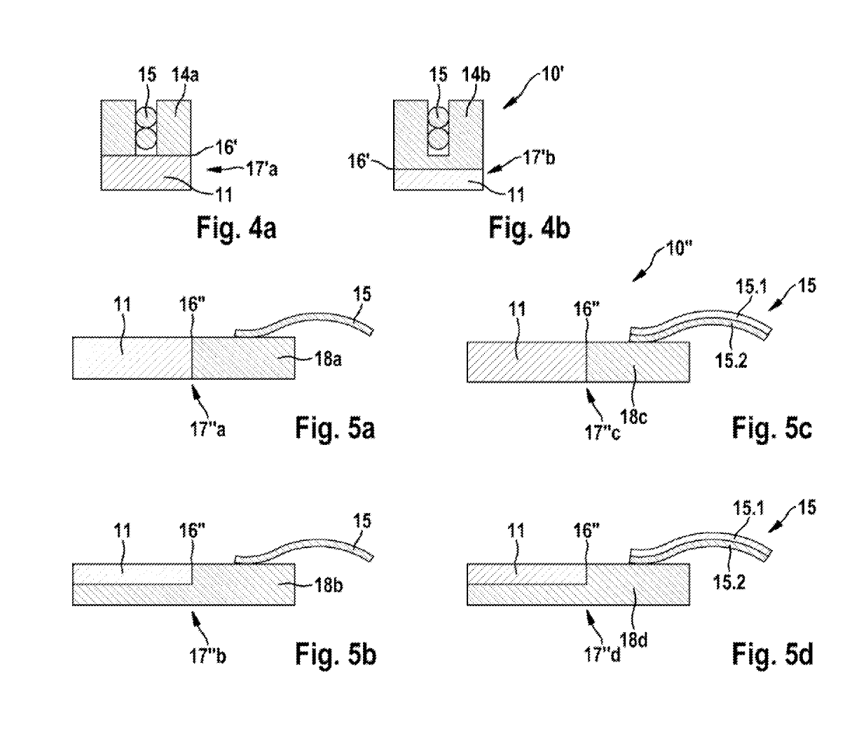

FIGS. 4a and 4b show schematic illustrations of embodiments in which the winding-side conductor is fastened to a winding-side contact portion in the form of a slot.

In detail, FIGS. 4a-4b show two embodiments of a contact element 10′ in which a winding-side contact portion 14a, 14b formed from the winding material is provided with a slot. The conductor 15 likewise formed from the winding material is inserted into the slot for contact and for example is fixed by press fitting or conductive gluing or welding.

In the embodiment according to FIG. 4a the slot is formed in the contact portion 14a as far as the feed-side contact portion 17′a formed from the second material.

In accordance with FIG. 4b by contrast, the slot is formed completely within the winding-side contact portion, such that, during production of the contact between the conductor 15 and the winding-side contact portion 14b, the conductor can be pushed through downwards without producing a multi-component connection.

The contact portion 17′a and 17′b is in this embodiment directly connected to the feed-side contact portion 11 and thus forms a multi-component connection 16′.

FIGS. 5a-5d show schematic illustrations of four embodiments 10″ of a contact element with feed-side contact face 11 and welded-on conductor 15.

According to FIG. 5a, a winding-side contact portion 18a formed from winding material is connected with end-face abutment to the feed-side contact face 11 formed from the second material and thus forms a multi-component connection 16″. A conductor 15 formed from the winding material and leading to the winding arrangement is welded to the winding-side contact portion 18a.

The conductor 15, which leads to the winding arrangement, is formed from the winding material and is welded or soldered or conductively glued to the winding-side contact portion 18a.

FIG. 5b, in contrast to the illustration of FIG. 5a, shows that the contact face 11 is formed only in a surface portion of a winding-side contact portion 18b formed from the winding material. The multi-component connection 16″ thus has the form of a half-trough.

The contact element shown in FIG. 5c corresponds to that shown in FIG. 5a, only in this case the conductor 15, which leads to the winding arrangement, is formed from two different materials. The conductor 15 is specifically formed at least in one region of the winding-side contact portion 18c from a portion 15.2 formed from the winding material and a portion 15.1 consisting of another material. The portion 15.2 formed from the winding material is welded to the winding-side contact portion 18c of the contact element 10″. The portion 15.1 formed from the other material faces away from the winding-side contact portion 18c of the contact element 10″.

The contact element shown in FIG. 5d corresponds to that shown in FIG. 5b, only here the conductor 15, which leads to the winding arrangement, is formed as in the embodiment shown in FIG. 5c.

The contact portion 17″a to 17″d providing the multi-component connection 16″ is directly connected to the feed-side contact portion 11 in each of the embodiments shown in FIGS. 5a to 5d.

In the described embodiments it is envisaged that the multi-component connection between the winding-side contact portion and the feed-side contact portion is provided by one of WIG welding, TIG welding, MIG welding, MAG welding, resistance welding, friction welding, laser welding, soldered connection with flux agent, and soldered connection without flux agent, and also with or without ultrasound assistance.

In addition, a contact arrangement is envisaged, comprising a contact element as described above and a conductor 15 connecting the winding-side contact portion to the winding arrangement, wherein the conductor 15 is formed from two portions 15.1, 15.2 formed from different materials.

Lastly, an electric machine, in particular in a motor vehicle, is provided that is formed in such a way that contact to a winding arrangement in the electric machine is formed by a contact element formed as above and/or by a contact arrangement provided as above.

1. A contact element (10; 10′; 10″; 10′″) configured to provide electrical contact to a winding arrangement of an electric machine, comprising:
a first contact portion (13; 14; 18; 21′) formed from a first material; and
a second contact portion (11; 17′; 11; 23) formed from a second material that is different from the first material,
wherein the first contact portion (13; 14; 18; 21′) and the second contact portion (11; 17′; 11; 23) are connected by a multi-component connection (16; 16′; 16″; 16′″).

2. The contact element as claimed in claim 1, wherein the first contact portion (13; 14; 18; 21′) is directly connected to the second contact portion (11c; 11h; 17′; 11; 23) and thus provides the multi-component connection (16c; 16h; 16′; 16″; 16′″).

3. The contact element as claimed in claim 1, wherein the first contact portion (13) is indirectly connected to the second contact portion (11a; 11b; 11d; 11 e; 11f; 11g; 11i) via a third contact portion (17a; 17b; 17d; 17e; 17f; 17g; 17i) providing the multi-component connection (16a; 16b; 16d; 16e; 16f; 16g; 16i).

4. The contact element as claimed in claim 1, wherein the first material is formed substantially from or with aluminum or a material compatible with aluminum.

5. The contact element as claimed in claim 1, wherein the second material is formed substantially from or with copper or a material compatible with copper.

6. The contact element as claimed in claim 1, wherein the electric machine is one of a DC motor, an EC motor, a generator and a transformer.

7. The contact element as claimed in claim 1, wherein the multi-component connection (16; 16′; 16″; 16′″) of the first contact portion (13; 14; 18; 21′) to the second contact portion (11; 17′; 11; 23) is provided by one of WIG welding, TIG welding, MIG welding, MAG welding, resistance welding, friction welding, laser welding, soldered connection with flux agent, and soldered connection without flux agent.

8. A contact arrangement for providing electrical contact to a winding arrangement of an electric machine, comprising
a contact element (10; 10′; 10″; 10′″) as claimed in claim 1; and
a conductor (15) connecting the first contact portion (18c; 18d) of the contact element to the winding arrangement.

9. The contact arrangement as claimed in claim 8, wherein the conductor (15) is formed, at least in a region of the first contact portion (18c; 18d), from a first conductor portion (15.1) formed from a third material and from a second conductor portion (15.2) formed from a fourth material and connected to the first contact portion (18c; 18d).

10. The contact arrangement as claimed in claim 9, wherein the fourth material is identical to or compatible with the first material.

11. An electric machine, wherein contact between a connector of the machine and a winding arrangement in the electric machine is formed by a contact element as claimed in claim 1.

12. An electric machine, wherein contact between a connector of the machine and a winding arrangement in the electric machine is formed by a contact arrangement as claimed in claim 9.

13. The electric machine as claimed in claim 12, wherein contact between a connector of the machine and a winding arrangement in the electric machine is also formed by a contact element comprising:
a first contact portion (13; 14; 18; 21′) formed from a first material; and
a second contact portion (11; 17′; 11; 23) formed from a second material that is different from the first material,
wherein the first contact portion (13; 14; 18; 21′) and the second contact portion (11; 17′; 11; 23) are connected by a multi-component connection (16; 16′; 16″; 16′″).

14. The contact element as claimed in claim 7, wherein the multi-component connection (16; 16′; 16″; 16′″) of the first contact portion (13; 14; 18; 21′) to the second contact portion (11; 17′; 11; 23) is provided with ultrasound assistance.

15. The contact element as claimed in claim 7, wherein the multi-component connection (16; 16′; 16″; 16′″) of the first contact portion (13; 14; 18; 21′) to the second contact portion (11; 17′; 11; 23) is provided without ultrasound assistance.
